(19) United States
(12) Patent Application Publication
(10) Pub. No.: US 2012/0303942 A1
(43) Pub. Date: Nov. 29, 2012

(54) CACHING OF BOOT DATA IN A STORAGE DEVICE

(76) Inventor: Eric Peacock, Sunnyvale, CA (US)

(21) Appl. No.: 13/115,236

(22) Filed: May 25, 2011

(51) Int. Cl. G06F 15/177

(52) U.S. Cl. 713/2; 711/E12.017

(57) ABSTRACT

Example embodiments relate to caching data in a storage device. In example embodiments, a storage device is configured to receive a command to access data on the storage device. In response, the storage device may determine whether a computing device to which the storage device is coupled is currently booting. When the computing device is currently booting, the storage device may cache the data in a first portion of a cache used to cache boot data.

### BACKGROUND

Storage devices commonly include a cache, which is typically maintained in a portion of storage with faster access times than the remaining portions of storage. For example, a hybrid storage device generally includes rotating media for storing data and a non-volatile memory for caching portions of the stored data. By storing frequently-accessed blocks of data in the cache, the storage device allows future access requests to those blocks to be processed more quickly. Because the size of the cache is typically limited given the cost of the faster memory technology, optimizing the use of the cache in such devices is an important consideration.

### BRIEF DESCRIPTION OF THE DRAWINGS

The following detailed description references the drawings, wherein:

FIG. 1 is a block diagram of an example storage device for caching boot data in a dedicated portion of a cache;

FIG. 2 is a block diagram of an example hybrid storage device for caching boot data in a dedicated portion of a cache based at least on storage commands provided by a processor of a coupled computing device;

FIG. 3 is a flowchart of an example method for caching data in a cache of a storage device based on whether a coupled computing device is currently booting;

FIG. 4A is a flowchart of an example method for determining whether a computing device is booting based on occurrence of two conditions associated with a boot;

FIG. 4B is a flowchart of an example method for determining whether a computing device is booting based on occurrence of N conditions associated with a boot; and

FIG. 5 is a block diagram of an example sequence of operations for caching data in a storage device based on accesses by a coupled computing device.

### DETAILED DESCRIPTION

As detailed above, storage devices commonly include a cache for storing frequently-accessed files for subsequent access. In some hybrid drive solutions, an operating system of a computing device may be configured to use a process known as “pinning” to write predetermined types of data to the non-volatile memory. For example, the operating system may be configured to store a set of boot files in a section of the non-volatile memory, such that the computing device boots more quickly.

Because the operating system manages the pinning process in these solutions, a storage driver and/or other software is required to ensure that the cache contains the desired boot files. As a result, the manufacturer of the storage device, developer of the operating system, or another entity must develop a driver and/or other software to handle this procedure. Furthermore, because drivers are typically specific to each operating system, a separate driver must be developed for each operating system. Finally, the driver and other software must be installed within the operating system, which can be a time consuming and frustrating process in some instances. Ultimately, these factors create additional barriers to effectively implementing a storage device that reduces the boot time of the coupled computing device.

To address these issues, example embodiments disclosed herein relate to a storage device for storing boot files in a memory of the storage device independently of an operating system. For example, a storage device may be configured to receive commands to access data on the storage device or to perform other operations. In response, the storage device may determine whether a computing device to which the storage device is coupled is currently booting based on the commands. When the computing device is currently booting, the storage device may cache the data in a first portion of a cache used to cache boot data. Alternatively, when the computing device is not currently booting, the storage device may cache the data in a second portion used for non-boot data. As a result, the boot portion of the cache is only modified during a boot of the computing device, such that this portion may be accessed during subsequent boots, thereby significantly reducing the boot time of the device.

In this manner, example embodiments disclosed herein provide for a storage device that reduces boot times without requiring drivers, BIOS modifications, or other customized software. In particular, because the controller of the storage device determines whether the computing device is booting, the solution is independent of the BIOS, operating system, drivers, and other software used in the computing device. As a result, a computer manufacturer, user, or other entity may simply install the storage device in a computing device and obtain the benefit of decreased boot time without modification of the operating system or other software. Additional embodiments and advantages of such embodiments will be apparent to those of skill in the art upon reading and understanding the following description.

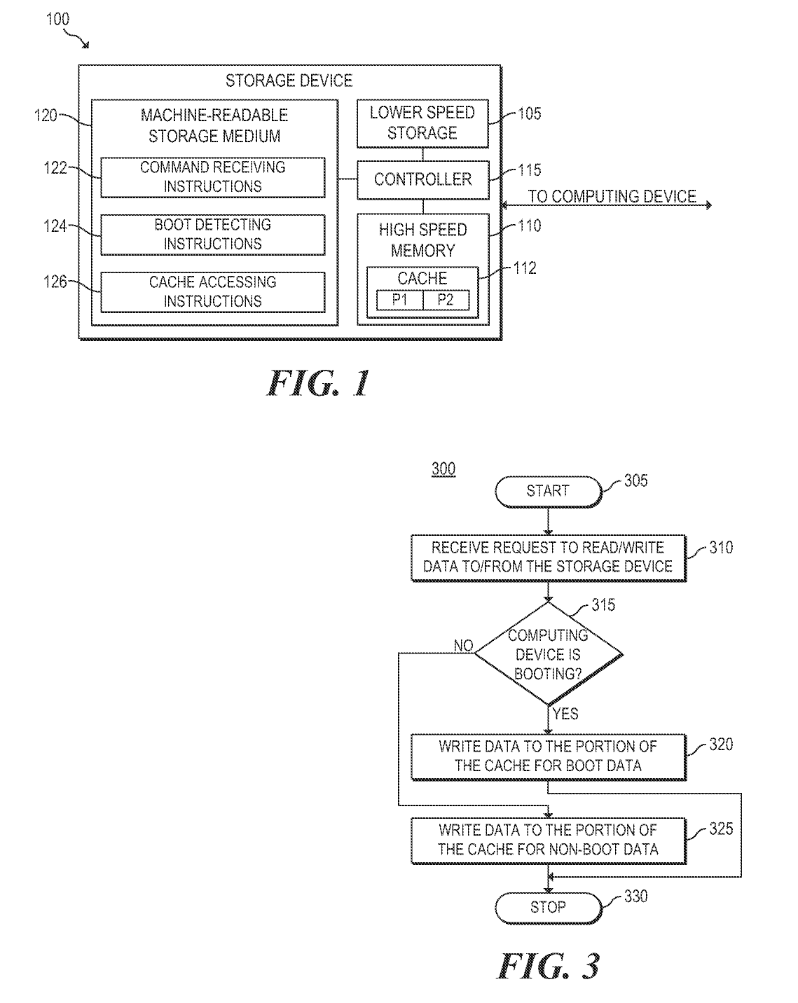

Referring now to the drawings. FIG. 1 is a block diagram of an example storage device 100 for caching boot data in a dedicated portion P1 of a cache 112. Storage device 100 may be any storage device that includes a cache 112 for storing frequently-accessed data. Thus, storage device 100 may be a hybrid storage drive including lower speed storage 105 and high speed memory 110. Storage device 100 may also include a controller 115 and a machine-readable storage medium 120.

In implementations in which storage device 100 is a hybrid drive, lower speed storage 105 may be used to store all data maintained on device 100. In general, lower speed storage 105 may be less expensive than high speed memory 110 and may be slower in comparison to high speed memory 110. For example, lower speed storage 105 may be a hard disk drive including a number of rotating platters. In should be noted, however, that lower speed storage 105 is not limited to rotating media; rather, lower speed storage 105 may be any type of storage suitable for use as the primary storage location in storage device 100.

In contrast to lower speed storage 105, which is used to store all data maintained on device 100, high speed memory 110 may be used to selectively store a subset of data in a cache 112. For example, high speed memory 110 may be a non-volatile memory, such as a flash memory device or a solid state drive. Alternatively, high speed memory 110 may be a volatile memory, such as Random Access Memory (RAM), provided that memory 110 is coupled to a backup battery for maintaining the data when storage device 100 is powered down. Regardless of the particular implementation, high speed memory 110 may be divided into multiple portions, P1 and P2, where each portion comprises a subset of sectors of memory 110. As detailed below, controller 115 may execute a series of instructions to selectively cache accessed data in either P1 or P2 of cache 112 based on whether a coupled computing device is currently booting.

Portion P1 may be a dedicated portion of memory 110 that is used to cache boot data. In some implementations, the size of P1 may be preset to a size determined to be substantially equal to a total size of all files accessed while booting a coupled computing device. For example, a typical operating system may access about 500 megabytes (MB) of data while booting a device, an P1 may be fixed to that size. As an alternative to fixing the size of P1, storage device 100 may dynamically adjust the size of P1 based on the files accessed subsequent to determining that the coupled computing device is booting. Portion P2 of cache 112 may comprise the remaining portion of memory 110 used to cache all other data and may itself be divided into portions for different types of data.

Controller 115 may be an electrical circuit that includes logic for managing the functionality of storage device 100. For example, controller 115 may be a processor, a semiconductor-based microprocessor, a microcontroller, or any other hardware device suitable for retrieval and execution of instructions stored in machine-readable storage medium 120. In particular, controller 115 may fetch, decode, and execute instructions 122, 124, 126 to implement the boot data caching technique described herein.

Machine-readable storage medium 120 may be a non-transitory electronic, magnetic, optical, or other physical storage device that contains or stores executable instructions for managing the caching process of storage device 100. As an example, machine-readable storage medium 120 may be a Read-Only Memory (ROM) chip that encodes instructions that are executable to implement the firmware of storage device 100. Controller 115 may execute the instructions encoded on machine-readable storage medium 120 to implement the functionality described in detail below.

Command receiving instructions 122 may receive commands to access the data maintained in storage device 100. For example, instructions 122 may receive a command to read data from storage device 100 or a command to write data to storage device 100. These commands may be Advanced Technology Attachment (ATA) commands defined according to the ATA specification or any other storage specification. In response to receipt of a read command, controller 115 may access the referenced data from either lower speed storage 105 or cache 112 and return the data to the processor of the coupled computing device. Similarly, in response to receipt of a write command, controller 115 may write the included data to lower speed storage 105.

In addition to servicing the data request by either reading or writing the appropriate data, storage device 100 may also cache the accessed data in cache 112 of high speed memory 110 in either portion P1 or P2. To determine whether to cache the data in P1 or P2, controller 115 may first execute boot detecting instructions 124, which may detect whether the computing device to which storage device 100 is coupled is currently booting.

In operation, storage device 100 generally does not receive an explicit command or indication from the computing device specifying that the computing device is booting. As a result, storage device 100 may detect whether the computing device is currently booting by monitoring for at least one predetermined storage command provided from the computing device to storage device 100. For example, in some implementations, controller 115 may trigger the monitoring in a firmware boot routine that is executed by controller 115 when power is provided to the device 100. Thus, when a computing device is initially powered on from a power off state and power is provided to the storage device 100, controller 115 may automatically begin monitoring for the predetermined commands.

The predetermined commands for which storage device 100 monitors may be commonly associated with a boot procedure. For example, storage device 100 may monitor for one or more of a reset command; a command requesting drive identification data; a Self-Monitoring, Analysis, and Reporting Technology (SMART) status command; or a read of the Master Boot Record (MBR) followed by a read of a partition boot record, as these commands are commonly provided when a computing device is booting. It should be noted that additional or alternative commands may be associated with a boot and therefore be monitored by storage device 100. Upon detecting one or more of these commands, storage device 100 may infer that the coupled computing device is booting.

Because these commands may occasionally be provided by the coupled computing device when the device is not booting, in some implementations, boot detecting instructions 124 may monitor for the occurrence of multiple commands. For example, upon detection of a first predetermined command, storage device 100 may begin monitoring for occurrence of a second predetermined command within a predetermined period of time from the first command. In some implementations, the predetermined period of time may be substantially equal to an amount of time required for a Basic Input/Output System (BIOS) of the computing device to initialize the system (e.g., approximately 14 seconds). As a result, when two or more commands generally associated with booting occur within the time window commonly required for the BIOS to initiate loading of the operating system, storage device 100 may infer that the computing device is booting.

After determining whether the computing device is currently booting, controller 115 may then trigger cache accessing instructions 126. Instructions 126 may trigger a write of the read or written data to either P1 or P2 depending on whether the computing device is determined to be booting. In particular, when instructions 124 determine that the computing device is currently booting, cache accessing instructions 126 may direct cache writes to portion P1, as this portion is dedicated to boot data. In contrast, when instructions 124 determine that the computing device is not currently booting, instructions 124 may direct cache writes to portion P2, as this portion is dedicated to non-boot data.

After detecting that the computing device is booting, cache accessing instructions 126 may write data to P1 until reaching a predetermined amount of data. The predetermined amount of data may be the total size of portion P1, such that writes to P1 are stopped when P1 is filled. Alternatively, cache accessing instructions 126 may track the total amount of data written to P1 and stop writes to P1 when reaching a predetermined size limit. This limit may be set to a value substantially equal to an estimated total size of files accessed by the computing device during boot (e.g., 500 MB). Alternatively, cache accessing instructions 126 may write data to P1 until reaching a predetermined amount of time. This predetermined amount of time may be substantially the amount of time required for the OS to boot. After reaching the predetermined amount of data or duration of time, cache accessing instructions 126 may resume directing cache writes to P2. It should be noted that, in some implementations, the writes to the cache may be deferred until a later time, rather than occurring immediately after detecting that the computing device is booting.

Thus, based on execution of instructions 122, 124, 126, controller 115 may write to cache 112 in a manner that optimizes the boot time of the coupled computing device. In particular, after writing boot data to P1 of cache 112 in memory 110, this data is available during a subsequent boot of the computing device. As a result, when this data is requested during the next boot, storage device 100 may quickly retrieve the data from cache 112 rather than lower speed storage 105, thereby reducing the time required for boot.

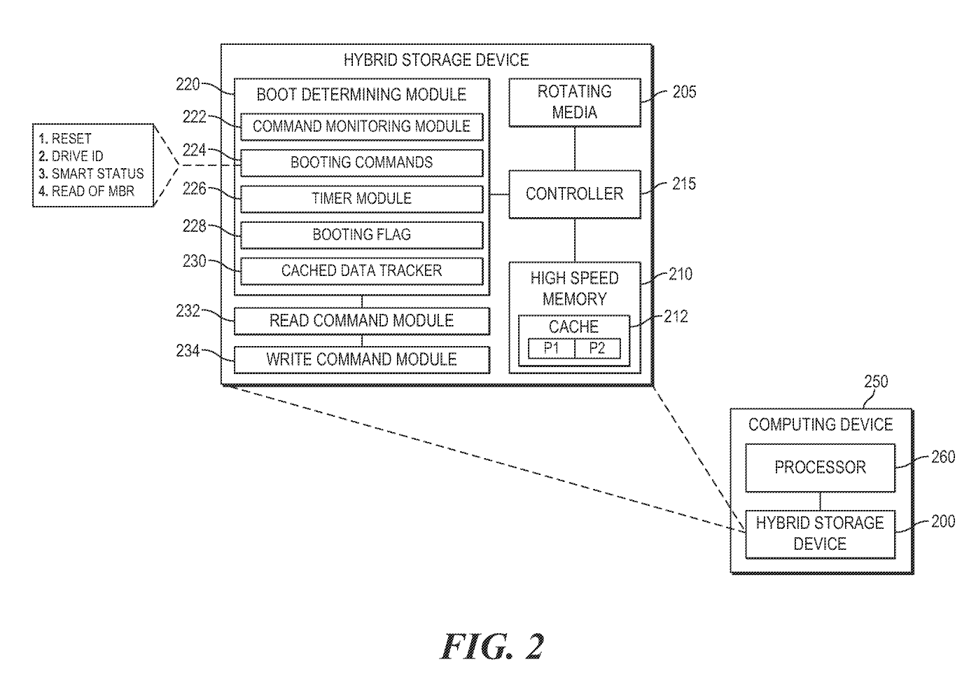

FIG. 2 is a block diagram of an example hybrid storage device 200 for caching boot data in a dedicated portion P1 of a cache 212 based at least on storage commands provided by a processor 260 of a coupled computing device 250. As illustrated, hybrid storage device 200 is coupled to computing device 250 and is in communication with a processor 260 of the computing device 250.

Hybrid storage device 200 may be any storage device including multiple forms of storage that operate at different speeds. For example, as illustrated, hybrid storage device 200 may include rotating media 205 and high speed memory 210, which may be flash memory, solid state storage, or Random Access Memory. High speed memory 210 may be any type of memory or storage that operates at a higher speed than rotating media 205 and is therefore suitable for maintaining cache 212. As with cache 112 of FIG. 1, cache 212 may be divided into two portions, including a first portion P1 for storing boot data and a second portion P2 for storing non-boot data. Similarly, as with controller 115 of FIG. 1, controller 215 may be any electrical circuit that includes logic for managing the functionality of storage device 200.

In addition to rotating media 205, high speed memory 210, and controller 215, hybrid storage device 200 may also include a series of modules 220-234. Each of the modules included in hybrid storage device 200 may be implemented as a series of instructions encoded on a machine-readable storage medium of storage device 200 and executable by controller 215. In addition or as an alternative, the modules 220-234 may be implemented as hardware devices including electronic circuitry for implementing the functionality described below.

Boot determining module 220 may be configured to determine whether computing device 250 is currently performing a boot procedure based on the storage commands provided from processor 260 to storage device 200. For example, command monitoring module 222 may monitor the storage commands received by controller 215 from processor 260 to determine whether the commands include a command identified by booting commands 224. An example list of predetermined booting commands 224 commonly associated with a boot of a computing device is detailed below:

TABLE 1
Example Commands To Be Monitored

| Opcode | Command Description |
|---|---|
| 0x08 | Device reset |
| 0xEC | Identify device |
| 0xB0 | SMART command |
| 0x25 (LBA = 0x00) | Read of Master Boot Record |

In operation, command monitoring module 222 may begin monitoring for occurrence of a storage command identified in the list of booting commands 224 after occurrence of an initial condition. In some implementations, the initial condition may be a power on operation of storage device 200, such that a boot routine of storage device 200 triggers the monitoring as part of the power on sequence. In other implementations, the initial condition may itself be detection of a storage command included in booting commands 224. Regardless of the implementation, upon occurrence of the first condition, command monitoring module 222 may begin monitoring for occurrence of a predetermined number of commands included in booting commands 224 within a given time period. In tracking this time period, module 222 may utilize an instance of timer module 226, which may be used to track an elapsed period of time subsequent to receipt of a start instruction.

During a typical boot sequence, commands from booting commands 224 may be expected to occur in a particular order. For example, the initial command may generally be a reset command, followed by a device identification command, then a SMART command, and finally a read of the MBR followed by a read of a partition boot record. As a result, in some implementations, command monitoring module 222 may determine whether the detected commands that are included in boot commands 224 are received in the proper order and only infer that computing device 250 is booting when the ordering is satisfied.

When command monitoring module 222 determines that computing device 250 is booting based on occurrence of the predetermined number of commands in booting commands 224 within a given time period, it may then set booting flag 228 to “True.” As detailed below, modules 232, 234 may then begin writing data to P1, the boot portion of cache 212. Cached data tracker 230 may then begin tracking a total amount of data written to P1 since the determination that computing device 250 is booting. Alternatively, timer module 226 may begin tracking an elapsed duration of time since the boot determination. After a predetermined amount of data has been written to portion P1 of cache 212 as determined by cached data tracker 230 or a predetermined duration of time has passed as determined by an instance of timer module 226, command monitoring module 222 may then set booting 228 flag to “False.” Modules 232, 234 may then resume writing data to P2, the non-boot portion of cache 212.

Read command module 232 may receive and process read commands provided to storage device 200 by processor 260 of computing device 250. In response to a read command, module 232 may first determine whether the requested data block is available in cache 212 and, if so, return the block to processor 260. Otherwise, module 232 may access the requested block from rotating media 205 and return the block to processor 260. In addition to returning the data to computing device 250, read command module 232 may also write the requested data to the appropriate portion of cache 212. In particular, when booting flag 228 is currently set to “True,” module 232 may write the block to P1 of cache 212. Alternatively, when booting flag is currently set to “False,” module 232 may write the block to P2 of cache 212.

Write command module 234 may similarly receive and process write commands provided to storage device 200 by processor 260 of computing device 250. In response to a write command, module 234 may identify an appropriate location in rotating media 205 and store the provided data block in the identified location and also write the data to the appropriate portion of cache 212. In particular, when booting flag 228 is currently set to “True,” module 234 may write the block to P1 of cache 212. Alternatively, when booting flag is currently set to “False,” module 234 may write the block to P2 of cache 212.

Computing device 250 may be a notebook computer, a desktop computer, an all-in-one system, a tablet computing device, a surface computer, a portable reading device, a wireless email device, a mobile phone, or any other computing device capable of communication with hybrid storage device 200 via a cable, bus, wireless connection, or other communication mechanism. Computing device 250 may include a processor 260, which may be one or more central processing units (CPUs), semiconductor-based microprocessors, and/or other hardware devices suitable for retrieval and execution of instructions. In operation, processor 260 may transmit commands to hybrid storage device 200 to access data or otherwise control the operation of storage device 200. As detailed above, these commands may be analyzed by storage device 200 to determine whether computing device 250 is booting and to thereby control writes to cache 212.

FIG. 3 is a flowchart of an example method 300 for caching data in a cache of a storage device 100, 200 based on whether a coupled computing device is currently booting. Although execution of method 300 is described below with reference to storage devices 100, 200, other suitable components for execution of method 300 will be apparent to those of skill in the art. Method 300 may be implemented in the form of executable instructions stored on a machine-readable storage medium, such as storage medium 120, and/or in the form of electronic circuitry.

Method 300 may start in block 305 and continue to block 310, where storage device 100, 200 may receive a storage command from a coupled computing device. For example, storage device 100, 200 may receive a request to read data from storage 105, 205 or to write data to storage 105, 205.

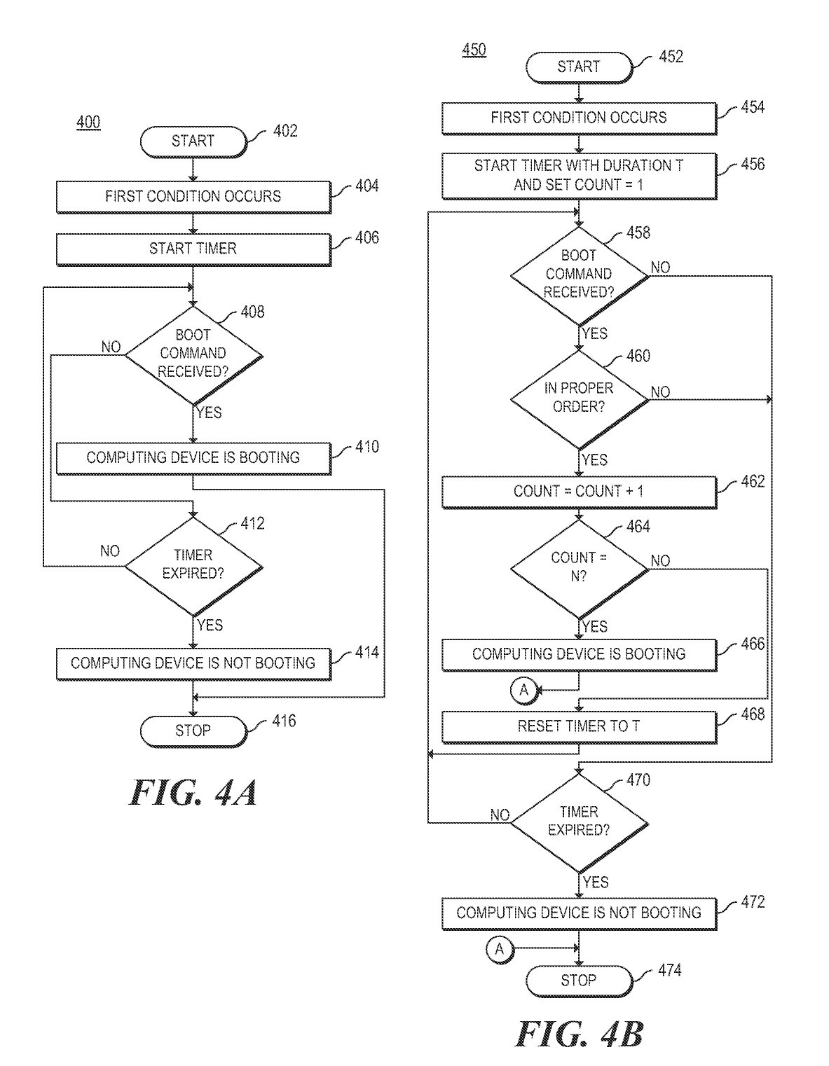

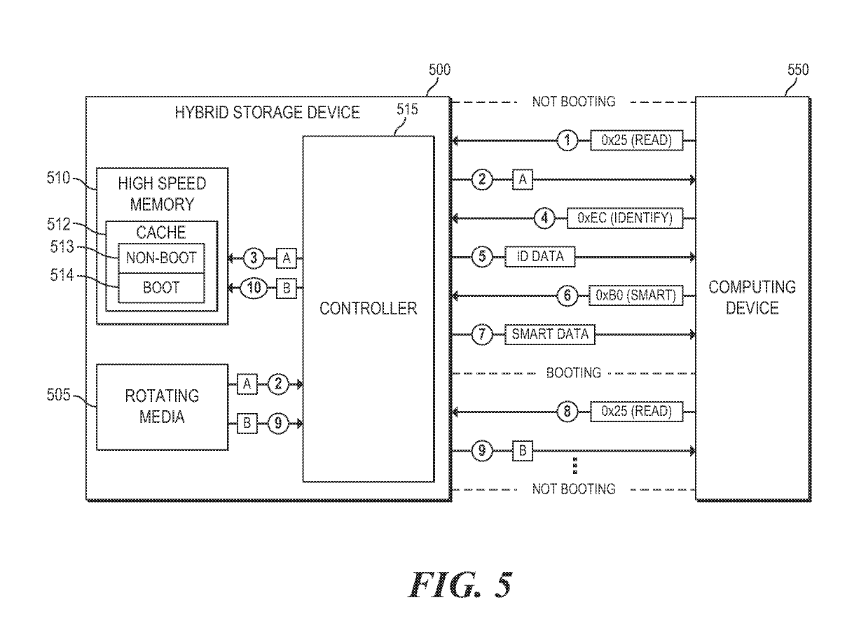

Upon receipt of such a command, method 300 may continue to block 315, where storage device 100, 200 may determine whether the computing device is currently booting. For example, storage device 100, 200 may determine whether the computing device is booting based on storage commands provided by the computing device. More specifically, storage device 100, 200 may determine whether the storage commands include at least one command commonly associated with a boot of a computing device. Two example methods for determining whether a computing device is currently booting are described in further detail below in connection with FIGS. 4A & 4B.

When storage device 100, 200 determines in block 315 that the computing device is currently booting, method 300 may proceed to block 320, where storage device 100, 200 may write the data to the subset of the cache reserved for boot data. Alternatively, when storage device 100, 200 determines in block 315 that the computing device is not currently booting, method 300 may proceed to block 325, where storage device 100, 200 may write the data to the subset of the cache used for non-boot data. After writing the data to the appropriate subset of the cache in either block 320 or block 325, method 300 may then continue to block 330, where method 300 may stop.

FIGS. 4A & 4B are flowcharts of example methods 400, 450 for execution by storage devices 100, 200 in determining whether a coupled computing device is booting. In some implementations, methods 400, 450 may be executed as part of block 315 of method 300 of FIG. 3 and may be repeatedly executed to determine whether a coupled computing device is booting. Although execution of methods 400, 450 is described below with reference to storage devices 100, 200, other suitable components for execution of methods 400, 450 will be apparent to those of skill in the art. Methods 400, 450 may be implemented in the form of instructions executable by a controller and/or in the form of electronic circuitry.

FIG. 4A is a flowchart of an example method 400 for determining whether a computing device is booting based on occurrence of two conditions associated with a boot. Method 400 may start in block 402 and continue to block 404, where a first condition associated with a boot process occurs. For example, storage device 100, 200 may be powered on in response to the coupled computing device receiving power. As a result, a firmware boot routine in storage device 100, 200 may trigger monitoring for occurrence of a command associated with a boot, as detailed below. Alternatively, when the drive is already powered on, the first condition may be occurrence of a command commonly associated with a boot procedure and detection of this command by storage device 100, 200.

Regardless of the implementation, after occurrence of the first condition, method 400 may continue to block 406, where storage device 100, 200 may initiate a timer to begin tracking the time elapsed from occurrence of the first condition. In block 408, storage device 100, 200 may then determine whether a command commonly associated with a boot procedure has been received. If so, storage device 100, 200 may determine in block 410 that the computing device is booting, such that storage device 100, 200 thereafter directs writes to a boot portion of the cache. As detailed above, storage device 100, 200 may continue to direct writes to the boot portion until reaching either a predetermined amount of data or a predetermined duration of time. Method 400 may then stop in block 416.

Alternatively, when storage device 100, 200 determines in block 408 that a command associated with a boot procedure has not occurred, method 400 may continue to block 412. In block 412, storage device 100, 200 may determine whether the timer started in block 406 has expired. If the timer has not yet expired, method 400 may return to block 408 for continued monitoring for a command associated with a boot. Otherwise, when the timer has expired, storage device 100, 200 may determine that the computing device is not booting in block 414, such that storage device 100, 200 continues to direct writes to the non-boot portion of the cache. Method 400 may then stop in block 416.

FIG. 4B is a flowchart of an example method 450 for determining whether a computing device is booting based on occurrence of N conditions associated with a boot. Method 450 may start in block 452 and continue to block 454, where a first condition associated with a boot process occurs. For example, as detailed above in connection with block 404 of FIG. 4A, the first condition may be power-on of the storage device or the detection of a command commonly associated with a boot procedure.

After occurrence of the first condition, method 450 may continue to block 456, where storage device 100, 200 may initiate a timer to begin tracking the time elapsed from occurrence of the first condition. Storage device 100, 200 may also initialize a condition count variable to 1. In block 458, storage device 100, 200 may then determine whether a command commonly associated with a boot procedure has been received. If not, method 450 may continue to block 470, described in detail below. Otherwise, if storage device 100, 200 has received a command associated with a boot procedure, method 450 may continue to block 460.

In block 460, storage device 100, 200 may determine whether the command received in block 458 was received in the proper order. For example, when storage device 100, 200 expects to receive a set of commands in a predetermined order, storage device 100, 200 may compare the current command to the last-received command and determine whether the ordering of the commands is proper. If the commands are not in the expected order, method 450 may continue to block 470, described in detail below. Otherwise, storage device 100, 200 may increment the counter in block 462 and proceed to block 464.

In block 464, storage device 100, 200 may determine whether the counter is currently equal to N, such that N conditions have occurred. If so, storage device 100, 200 may determine in block 466 that the coupled computing device is booting. Storage device 100, 200 may then direct writes to the boot portion until reaching either a predetermined amount of data or a predetermined duration of time. Method 450 may then stop in block 474.

Alternatively, when storage device 100, 200 determines in block 464 that the counter is not equal to N, method 450 may continue to block 468, where storage device 100, 200 may reset the timer to T. Method 450 may then return to block 458, where storage device 100, 200 may continue to monitor for the receipt of additional storage commands associated with a boot procedure.

As detailed above, when a boot command is not received in block 458 or the commands are not in the proper order in block 460, method 450 may continue to block 470. In block 470, storage device 100, 200 may determine whether the tinier started in block 456 has expired. If the timer has not yet expired, method 450 may return to block 458 for continued monitoring for a command associated with a boot. Otherwise, when the timer has expired, storage device 100, 200 may determine that the computing device is not booting in block 472, such that storage device 100, 200 continues to direct writes to the non-boot portion of the cache. Method 450 may then stop in block 474.

FIG. 5 is a block diagram of an example sequence of operations for caching data in a storage device 500 based on accesses by a coupled computing device 550. As illustrated, a hybrid storage device 500 may include a high speed memory 510 including a cache 512 with a non-boot portion 513 and a boot portion 514. Hybrid storage device 500 may also include rotating media 505 and a controller 515. Hybrid storage device 500 may be in communication with computing device 550 via a cable, bus, wireless connection, or other communication mechanism. Note that, in the description that follows, it is assumed that the accessed data blocks, A and B, are not initially stored in the cache 512.

As illustrated, the sequence may start in block 1, where computing device 550 provides an ATA read command (opcode 0x25) requesting a data block from storage device 500. In response, in block 2, controller 515 retrieves the requested data block, block A, from rotating media 505 and returns block A to computing device 550. Because storage device 500 has determined that computing device 550 is not currently booting, in block 3, controller 515 may then store block A in the non-boot portion 513 of cache 512.

Next, in block 4, computing device 550 provides a command requesting identification data (opcode 0xEC) from hybrid storage device 500. In response, in block 5, hybrid storage device 500 returns the requested identification data to computing device 550. Note that, based on execution of method 400 or method 450, hybrid storage device 500 may then trigger a timer to begin monitoring of commands, as the identification data command is a command commonly associated with a boot procedure of a computing device.

In block 6, computing device 550 provides a command requesting SMART status information (opcode 0xB0) from hybrid storage device 500 before expiration of the timer. In response, in block 7, hybrid storage device 500 returns the requested SMART status information to computing device 550. In addition, because the SMART command is commonly associated with a boot procedure and because the command was received before expiration of the timer, hybrid storage device 500 determines that computing device 550 is currently booting.

Next, in block 8, computing device 550 again provides a read command and, in block 9, controller 515 accesses block B from rotating media 505 and returns block B to computing device 550. Note that, because hybrid storage device 500 has determined that computing device 500 is currently booting based on the identification command and SMART command, in block 10, controller 515 may then cache block B in the boot portion 514 of cache 512. Controller 515 may continue caching data in the boot portion 514 until reaching a predetermined data size limit or a predetermined time limit. After reaching the limit, hybrid storage device 500 may then determine that computing device 550 is no longer booting and that subsequent cache writes should be directed to non-boot portion 513.

According to the foregoing description, example embodiments optimize the boot time of a computing device by taking advantage of a cache included in a high speed memory of a storage device. In particular, example embodiments dedicate a portion of the cache to boot data and direct writes to this portion of the cache by determining in the storage device whether a coupled computing device is currently booting. In this manner, example embodiments provide an operating system agnostic solution for reducing boot time of a computing device by optimally using the cache.

I claim:

1. A storage device comprising:
a memory to maintain a cache, the cache including a first portion for caching boot data and a second portion for caching non-boot data; and
a controller to:
receive a command to read data from the storage device or write data to the storage device,
detect whether a computing device to which the storage device is coupled is currently booting, and
trigger a write of the read or written data to the first portion of the cache when the computing device is currently booting.

2. The storage device of claim 1, wherein a size of the first portion of the cache is substantially equal to a total size of all files accessed while booting the computing device.

3. The storage device of claim 1, wherein, to detect whether the computing device is currently booting, the controller is configured to:
monitor for at least one predetermined command provided from the computing device to the storage device, the at least one predetermined command associated with a boot procedure.

4. The storage device of claim 3, wherein the monitoring for the at least one predetermined command is triggered by a boot routine initiated when power is provided to the storage device.

5. The storage device of claim 3, wherein, to monitor for the at least one predetermined command, the storage device is configured to:
detect a first predetermined command, and
determine that the computing device is booting when at least a second predetermined command is received within a predetermined period of time from the first predetermined command.

6. The storage device of claim 5, wherein the predetermined period of time is substantially equal to an amount of time required for a Basic Input/Output System (BIOS) of the computing device to initialize the computing device.

7. The storage device of claim 3, wherein the at least one predetermined command is at least one of:
a reset command provided to the storage device,
a command requesting identification data from the storage device,
a command checking a Self-Monitoring, Analysis, and Reporting Technology (SMART) status of the storage device, and
a command accessing a Master Boot Record (MBR) of the storage device.

8. The storage device of claim 1, wherein, after detecting that the computing device is currently booting, the controller is configured to write the data to the first portion of the cache until reaching one of a predetermined amount of data and a predetermined period of time.

9. The storage device of claim 1, wherein the controller is further configured to:
trigger a write of the read or written data to the second portion of the cache when the computing device is not currently booting.

10. A computing device comprising:
a processor; and
a storage device comprising a memory for maintaining a cache, wherein the storage device receives storage commands from the processor and is configured to:
determine whether the computing device is currently performing a boot procedure based on the storage commands provided from the processor to the storage device,
cache data in a first portion of the cache when it is determined that the computing device is currently performing the boot procedure, and
cache data in a second portion of the cache when it is determined that the computing device is not currently performing the boot procedure.

11. The computing device of claim 10, wherein, to determine whether the computing device is currently performing the boot procedure, the storage device is configured to:
monitor for at least one predetermined command associated with the boot procedure after power is provided to the storage device.

12. The computing device of claim 10, wherein, to determine whether the computing device is currently performing the boot procedure, the storage device is configured to:
detect a first predetermined storage command, and
determine that the computing device is booting when at least a second predetermined storage command is received within a predetermined period of time from the first predetermined storage command.

13. A method for caching data in a cache maintained in memory of a storage device coupled to a computing device, the method comprising:
receiving, in the storage device, a plurality of storage commands provided by the computing device;
determining whether the computing device is currently booting by determining whether the storage commands include at least one command from a predetermined list of storage commands associated with a boot process; and
caching data in a first subset of the cache when it is determined that the computing device is currently booting.

14. The method of claim 13, further comprising:
caching data in a second subset of the cache when it is determined that the computing device is not currently booting.

15. The method of claim 13, wherein the determining comprises:
detecting a first command in the predetermined list of storage commands, and
determining that the computing device is booting when at least a second command in the predetermined list of storage commands is received within a predetermined period of time from the first command.
